(19) United States
(12) Patent Application Publication
(10) Pub. No.: US 2019/0200650 A1
(43) Pub. Date: Jul. 4, 2019

(54) COMPOSITIONS AND METHODS FOR STABILIZING MEAT SUBSTITUTE PRODUCTS

(71) Applicants: WISCONSIN ALUMNI RESEARCH FOUNDATION, Madison, WI (US); IOWA STATE UNIVERSITY RESEARCH FOUNDATION, INC., Ames, IA (US)

(72) Inventors: MARK P. RICHARDS, MADISON, WI (US); MARK HARGROVE, AMES, IA (US); SOFIA ERAZO-CASTREJON, MADISON, WI (US); JAGANNATHAN ALAGURAJAN, AMES, IA (US)

(73) Assignees: WISCONSIN ALUMNI RESEARCH FOUNDATION, MADISON, WI (US); IOWA STATE UNIVERSITY RESEARCH FOUNDATION, INC., AMES, IA (US)

(21) Appl. No.: 16/226,112

(22) Filed: Dec. 19, 2018

Related U.S. Application Data
(60) Provisional application No. 62/607,654, filed on Dec. 19, 2017.

(51) Int. Cl. A23L 3/34; A23L 3/36; A23L 29/00; A23J 3/18

(52) U.S. Cl. CPC A23L 3/34; A23L 3/36; A23L 29/03; A23L 29/015; A23J 3/18; A23V 2002/00; A23V 2250/5486; A23V 2200/10; A23V 2250/21; A23V 2250/032; A23V 2250/1614; A23V 2300/20; A23V 2200/06

(57) ABSTRACT

The disclosure provides for compositions and methods for preparation of meat substitutes containing clover hemoglobin. Even when oxidized, clover hemoglobin retains a red appearance, thereby avoiding common off-color events that plague other meat substitutes, such as those made using soybean hemoglobin.

### PRIORITY CLAIM

This application claims benefit of priority to U.S. Provisional Application Ser. No. 62/607,654, filed Dec. 19, 2017, the entire contents of which are hereby incorporated by reference.

### FEDERAL GRANT SUPPORT CLAUSE

This invention was made with government support under 2014-67017-21648 awarded by the USDA/NIFA. The government has certain rights in the invention.

### BACKGROUND OF THE DISCLOSURE

### 1. Field of the Disclosure

This disclosure relates to composition and methods for the preservation of meat substitutes products including plant heme protein. In particular, the use of clover hemoglobin which demonstrates more desirable color attributes than other plant hemoglobins.

### 2. Related Art

Meat analogs, also called meat alternatives, meat substitutes, mock meats, faux meats, imitation meats, or vegetarian/vegan “meats” are designed to approximate certain aesthetic qualities (primarily texture, flavor and appearance) and/or chemical characteristics of specific types of meat. Many analogs are soy-based (tofu, tempeh) or gluten-based. The growing interest in healthy diets, risks of animal-borne disease and concerns over unethical animal management practices all make meat analogs more highly sought after.

Unfortunately, soybean hemoglobin (also called Lba), which is currently used to provide red color to meat substitutes, readily turns brown upon storage due to oxidation of the heme iron in the globin of Lba. The inventor has previously described a process of stabilizing heme in meat substitutes through the use of heme-stabilizing agents. However, improved color stabilization approaches are needed. Moreover, there is some concern regardling the allergic potential of Lba.

### SUMMARY OF THE DISCLOSURE

Thus, in accordance with the present disclosure, there is provided a method of improving storage life of a meat analog comprising introducing into said meat analog a clover hemoglobin. The clover hemoglobin may be introduced at about 1-8 mg/g of meat analog, or at about 1-5 mg/g of meat analog. The clover hemoglobin may be Trifolium, such as Trifolium subterraneum.

The method may further comprise freezing said meat analog. The meat analog may be treated at 0 to 6° C. The method may further comprise treating said meat analog with a preservative. The method may further comprise treating said meat analog with an additive. The meat analog may retain red color and/or remains palatable at 0.6° C. for 2, 3, 4, 5, 6, 7, 8, 9, 10 or 14 days beyond the date upon which a meat analog not containing clover hemoglobin would no longer retain red color and/or be palatable.

The method may further comprise adjusting the pH of the meat analog to about 6.0-7.2, to about 6.0-6.8, to about 6.0-6.3, or to about 6.0. 6.1, 6.2, 6.3, 6.4, 6.5, 6.6, 6.7, 6.8, 6.9, 7.0, 7.1 or 7.2. The adjusting pH may comprise adding an acid solution to the meat analog, such as a hydrochloric acid solution, a sodium hydroxide acid solution, a citric acid solution, or sodium phosphate solution. The method may further comprise adding a buffering agent to stabilize pH of the meat analog.

Also provided is a meat analog containing comprising about 1 to 5 mg/g clover hemoglobin. The clover hemoglobin may be Trifolium or Trifolium subterraneum. The meat analog may contain less than 5% non-clover plant hemoglobin. The pH of the meat analog may be about 6.0-7.2, to about 6.0-6.8, to about 6.0-6.3, or to about 6.0. 6.1, 6.2, 6.3, 6.4, 6.5, 6.6, 6.7, 6.8, 6.9, 7.0, 7.1 or 7.2. The meat analog may further comprise a buffering agent to stabilize pH of the meat analog.

In yet another embodiment, there is provided a method of preparing a storage stable meat analog comprising (a) providing a meat analog; (b) adding to said meat analog a clover hemoglobin; and (c) packaging said meat analog for sale. The meat analog of step (c) may have less than 55% non-clover plant hemoglobin. The method may further comprise contacting said meat analog with at least one additional additive or preservation agent prior to step (c). The method may further comprise freezing said meat analog after step (c). Step (b) may comprise treatment at −20 to 6° C. The clover hemoglobin may be added at about 1-8 mg/g of meat analog, or at about 1-5 mg/g of meat analog.

It is contemplated that any method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.” The word “about” means plus or minus 5% of the stated number.

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description.

### BRIEF DESCRIPTION OF THE FIGURES

The following drawings form part of the present specification and are included to further demonstrate certain aspects of the present disclosure. The disclosure may be better understood by reference to one or more of these drawings in combination with the detailed description of the disclosure that follows.

FIG. 1A-D—Auto-oxidation profiles of soybean hemoglobin (LBA) and clover Hb (TSUD). (FIG. 1A) LBA spectra of ferric, deoxy-ferrous and oxy-ferrous state. (FIG. 1B) Time course of auto-oxidation for LBA as measured at 410 nM. (FIG. 1C) TSUD spectra of ferric, deoxy-ferrous and oxy-ferrous state. (FIG. 1D) Time course of auto-oxidation for TSUD as measured at 562 nM.

FIG. 2—Loss of redness (%) of clover leghemoglobin (TSUD) and soybean leghemoglobin (LBA) solutions during storage in the absence and presence of added nicotinic acid (NA) at pH 6 and 7. Heme protein concentration was 14 μmol/L. NA was added at 6 mol per mol of heme protein. The solutions were stored at 1-3° C. at 150-foot candles of light.

FIG. 3—Redness (a-values) of a wheat protein meat analog containing clover leghemoglobin (TSUD) at 160 μmol/kg (2.51 mg/g). The redness of analogs at pH 6 is shown with circles and that of analogs at pH 7 is shown with triangles. Open symbols were used for treatments without nicotinic acid (NA) and closed symbols were used for treatment containing 6 mol of NA per mol of leghemoglobin. The meat analog was wrapped with oxygen permeable film and stored at 1-3° C. at 150-foot candles of light.

FIG. 4—Redness (a-values) and images of meat analog containing 160 μmol of clover leghemoglobin (TSUD) per kg wet weight (2.51 mg/g) at pH 6 and pH 7, with or without 6 mol of nicotinic acid (6 NA) per mol of leghemoglobin. The analogue was stored at 1-3° C. and 150-foot candles of light.

### DESCRIPTION OF ILLUSTRATIVE EMBODIMENTS

Food preservation is a complicated process that requires both a means of preventing microbial contamination and a means of preventing the development of off-colors or off-flavors rendering the food unpalatable. Indeed, off-odor and off-flavor development during refrigerated and frozen storage of fish products is a major obstacle to consumer acceptance. This problem also plagues the meat analog industry, and the off-color aspect of meat analogs is a particular problem that has not been adequately resolved.

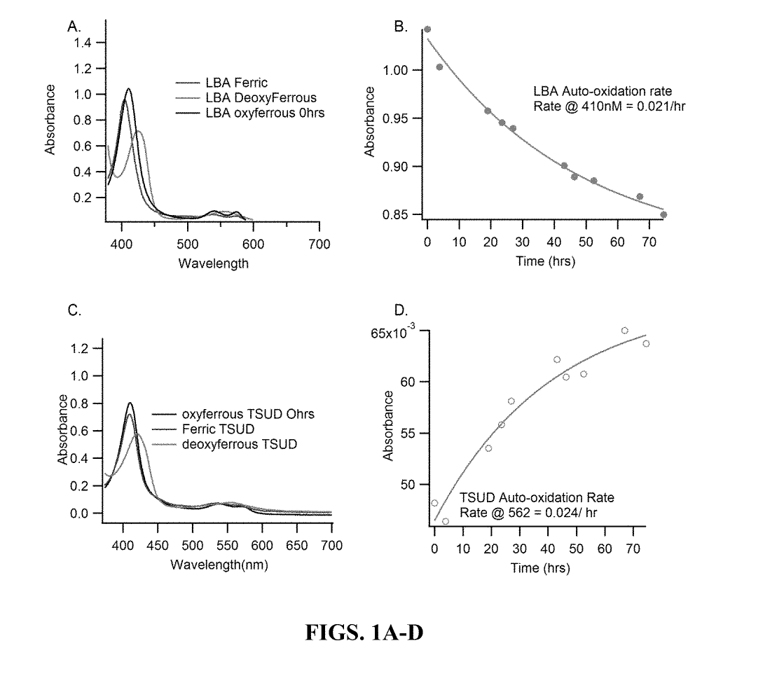

The present disclosure discloses the use of clover hemoglobin (Hb) as an alternative to soybean hemoglobin (Lba). Current technology uses Lba, which unfortunately oxidizes readily upon storage (i.e., the optical density in the Soret region of the reduced and oxidized forms of Lba are 410 nm (red) and 403 nm (brown), respectively (FIG. 1A). The inventors' approach was to express the clover hemoglobin gene in a bacterial host, purify the clover hemoglobin and assess its color properties. They had originally hoped that the clover hemoglobin would be resistant to oxidation due to having a different amino acid sequence compared to Lba. Clover hemoglobin was not, however, resistant to oxidation (FIGS. 1B & 1D). Surprisingly, the inventors discovered that the oxidized form of clover hemoglobin has an optical density peak in Soret region of 409 nm (FIG. 1C), which translates to red color. Thus, despite oxidation, a pleasing red color persists, largely addressing the off-color aspect of meat analog storage. These and other aspects of the disclosure are set out in detail below.

### I. MEAT ANALOGS

Meat analogs, also called meat alternatives, meat substitutes, mock meat, faux meat, imitation meat, or (where applicable) vegetarian meat or vegan meat, approximates certain aesthetic qualities (primarily texture, flavor and appearance) and/or chemical characteristics of specific types of meat. Many analogues are soy-based or gluten-based.

Generally, meat analogs are understood to mean a food made from non-meats, sometimes even without other animal products, such as dairy. The market for meat imitations includes vegetarians, vegans, non-vegetarians seeking to reduce their meat consumption for health or ethical reasons, and people following religious dietary laws in Judaism, Islam, Hinduism, and Buddhism.

In particular, meat analogs with added plant heme protein (e.g., clover hemoglobin) are defined as non-meat products containing plant heme protein in a range of about 1-8 mg/g, and more specifically about 1-5 mg/g. The rough amounts of heme proteins in poultry (0.2-3 mg/g), pork (1-3 mg/g) and beef (3-5 mg/g) may be used as approximate levels of added heme protein that would be needed to provide red color to the meat analog. The heme proteins that impart color in meat products will be similar to the milligrams of plant heme protein that would need to be added to a meat analog to impart red color.

The following is a list of various types of meat analogs: Alpro (known for their plant milk range, also different vegetarian meat substitutes); Beanfeast; Beyond Meat; Boca Burger; Falafel; Ganmodoki; Gardein; Gardenburger; Glamorgan sausage; Jackfruit, Koya-dofu; Leaf protein concentrate; Mock duck; Nut roast; Okara; Paneer; Quorn; Tempeh; Tofu; Tofurkey; Welsh rarebit; Wheat gluten.

### II. CLOVER HEMOGLOBIN

A. Clover

Clover or trefoil are common names for plants of the genus Trifolium, consisting of about 300 species of plants in the leguminous pea family Fabaceae. The genus has a cosmopolitan distribution; the highest diversity is found in the temperate Northern Hemisphere, but many species also occur in South America and Africa, including at high altitudes on mountains in the tropics. They are small annual, biennial, or short-lived perennial herbaceous plants. Clover can be evergreen. The leaves are trifoliate (rarely quatrefoiled (four-leaf clover), cinquefoil, or septfoil), with stipules adnate to the leaf-stalk, and heads or dense spikes of small red, purple, white, or yellow flowers; the small, few-seeded pods are enclosed in the calyx. Other closely related genera often called clovers include Meldotus (sweet clover) and Medicago (alfalfa or Calvary clover). Trifolium subterraneum, the subterranean clover (often shortened to sub clover), is a species of clover native to northwestern Europe, from Ireland east to Belgium. The plant's name comes from its underground seed development (geocarpy), a characteristic not possessed by other clovers. It can thrive in poor-quality soil where other clovers cannot survive, and is grown commercially for animal fodder. There are three distinct subspecies used in agriculture, each with its own ideal climate and soil type, allowing for wide distribution of the plant over varied environments.

There are 245 recognized species of clover. On of these, T. subterraneum subsp. Subterraneum, is the considered the generalist subspecies and can be grown in the widest range of environments T. subterraneum subsp. yanninicum is grown in moist areas that are prone to flooding. T. subterraneum subsp. brachycalycinum is a more sensitive plant, requiring dry, cracked soil for its germination.

Some systematists consider the three plants to be separate species. There are many strains and varieties of these subspecies, but few are in wide use. The technique of mixing the subspecies in one field is popular as a method of ensuring a dense crop. Also, subterranean clover is sometimes mixed with alfalfa for a longer-lasting grazing pasture.

This species is self-fertilizing, unlike most legume forage crops such as alfalfa and other clovers, which are pollinated by insects, especially honeybees. The flowers of subclover are often located beneath its leaves and are low in nectar, making access both difficult and unappealing for bees. These characteristics also make the plant less attractive to certain types of pest insects.

Subterranean clover is one of the most commonly grown forage crops in Australia. It is also grown in places such as California and Texas, where the extreme ranges of soil type and quality, rainfall, and temperature make the variable tolerances of sub clover especially useful.

B. Clover Hemoglobin

The sequence of clover hemoglobin protein was obtained from GenBank (GAU42437.1). The gene was reverse engineered from the protein sequence and codon optimized for optimal expression in bacterial system. The gene was then synthesized using the Geneart platform from Thermofisher Scientific. The synthesized gene was sub-cloned into an expression vector pET302NT-His (Thermofisher Scientific) using EcoRI and AvrII Restriction enzymes for bacterial expression.

Clover hemoglobin protein was expressed using BL21(DE3) cells grown in Terrific broth. The media was inoculated with 1% inoculum from an O/N culture and grown at 37° C. for 24 hrs. Purification was achieved during refolding of the protein. The cells were spun down and lysed by sonication. The lysate was then centrifuged and supernatant discarded. The pellet is re-solubilized in 6M Guanidine Hydrochloride (GDCL2) solution using a homogenizer. This solution is further centrifuged to clarify it of any particulates and un-dissolved cell material. The supernatant thus obtained is incubated with hemeB (0.05 g per liter of cell culture) for 30 min on ice. This solution containing the protein and HemeB is refolded via dialysis into 100 mM KPO₄ buffer, ph 7.0. The dialysate is centrifuged to give refolded protein in the supernatant. The purity of the protein thus obtained is >90% and used for this study. Final Storage Buffer was 100 mM KPO₄ buffer, pH 7.0.

### III. PRESERVATION COMPOSITIONS

The unique amino acid sequence of clover Hbs, compared to other plant Hbs such as that from soybean, confers a desirable color in meat analog, even as clover Hb is converted from its reduced to oxidized form. All clover Hbs are considered as having this unique property of color stability, as exemplified by Trifolium or Trifolium subterraneum as characterized herein.

As shown in a separate filing, the inventor has determined that reducing pH below neutral levels can affect the color of the plant Hb in the meat analog matrix. In general, the goal would be to establish a pH of about 6.0, although any adjustment below neutral pH, such as 6.0-7.2, or even lower, will be effective. Specific pH values of 6.0. 6.1, 6.2, 6.3, 6.4, 6.5, 6.6, 6.7, 6.8, 6.9, 7.0, 7.1 and 7.2 are contemplated.

A dilute solution (e.g., hydrochloric acid or sodium hydroxide) can be used to effectively adjust the pH to a range of 6.0-6.6. The presence of histidine (pKa ˜6) in plant proteins of the meat analog will function to hold the material at the desired pH. Alternatively, a buffer such as citric acid with a pKa of 5.4 (buffer range of 4.4 to 6.4) would work for pH 6.0 and pH 6.3. Sodium phosphate has a pKa of 7.2 (buffer range 6.2-8.2), which would be suitable for for pH 6.3 and pH 6.6.

The acids will be, for example, diluted in an aqueous material used in the formulation process, and then mixed with other ingredients to form the meat analog.

### IV. METHODS OF PRESERVING MEAT ANALOGS

Clover Hb will be incorporated into meat analog matrix to provide red colors and hues. The clover Hb may be introduced at any time prior to packaging, and maybe be mixed using motorized mixers. Alternatively, the meat analog may be dispersed to facilitate treatment, and an aerosol or mist comprising clover Hb may be applied to the meat analog. The clover Hb can be added to the meat analog at refrigeration temperatures to meet good manufacturing practices but can also be added at other temperatures that may be used to prepare the meat analog.

pH adjustment between 6.0 and 7.2 may be be performed. The pH adjustments will be made in the clover Hb prior to incorporation into other ingredients of the meat analog. Typical food grade buffers will then be used to finalize the pH in the meat analog if necessary.

### V. EXAMPLES

The following examples are included to demonstrate particular embodiments of the disclosure. It should be appreciated by those of skill in the art that the techniques disclosed in the examples which follow represent techniques discovered by the inventor to function well in the practice of the disclosure, and thus can be considered to constitute particular modes for its practice. However, those of skill in the art should, in light of the present disclosure, appreciate that many changes can be made in the specific embodiments which are disclosed and still obtain a like or similar result without departing from the spirit and scope of the disclosure.

### Example 1—Materials and Methods

Nomenclature.

TSUD—hypothetical protein TSUD_247790 (Trifolium subterraneum). LBA—Soya bean Leghemoglobin.

The autoxidation of TSUD was compared against LBA autoxidation. The soret/visible region of the hemoglobin spectrum was monitored to observe the oxidation of oxyferrous hemoglobins. The wavelength reported and their significance are as follows:

LBA Spectrum (FIG. 1A):
403 nM—LBA Ferric Absorbance Max
410 nM—LBA oxy-ferrous Absorbance Max
425 nM—LBA deoxy-ferrous Absorbance Max

TSUD Spectrum (FIG. 1C):
409 nM—TSUD Ferric Absorbance Max
411 nm—TSUD oxy-ferrous Absorbance Max (Hypothetical)
421 nM—TSUD deoxy-ferrous Absorbance Max
562 nM—TSUD ferric Absorbance max (Visible Region)

The rate of autoxidation was determined by fitting an exponential equation to the time course as indicated FIGS. 1B & 1D. These proteins have similar auto-oxidation rates of 0.021/hr and 0.024/hr for LBA and TSUD respectively.

### Example 2—Results

FIGS. 1A-D shows the auto-oxidation profiles of LBA and TSUD. FIG. 1A shows LBA spectra of ferric, deoxy-ferrous and oxy-ferrous state, and FIG. 1B shows a time course of auto-oxidation for LBA as measured at 410 nM. FIG. 1C shows TSUD spectra of ferric, deoxy-ferrous and oxy-ferrous state, while FIG. 1D shows time course of auto-oxidation for TSUD as measured at 562 nM. As can be seen, clover hemoglobin was not resistant to oxidation (FIG. 1B and FIG. 1D), but the oxidized form has an optical density peak in Soret region of 409 nm (FIG. 1C), which translates to red color.

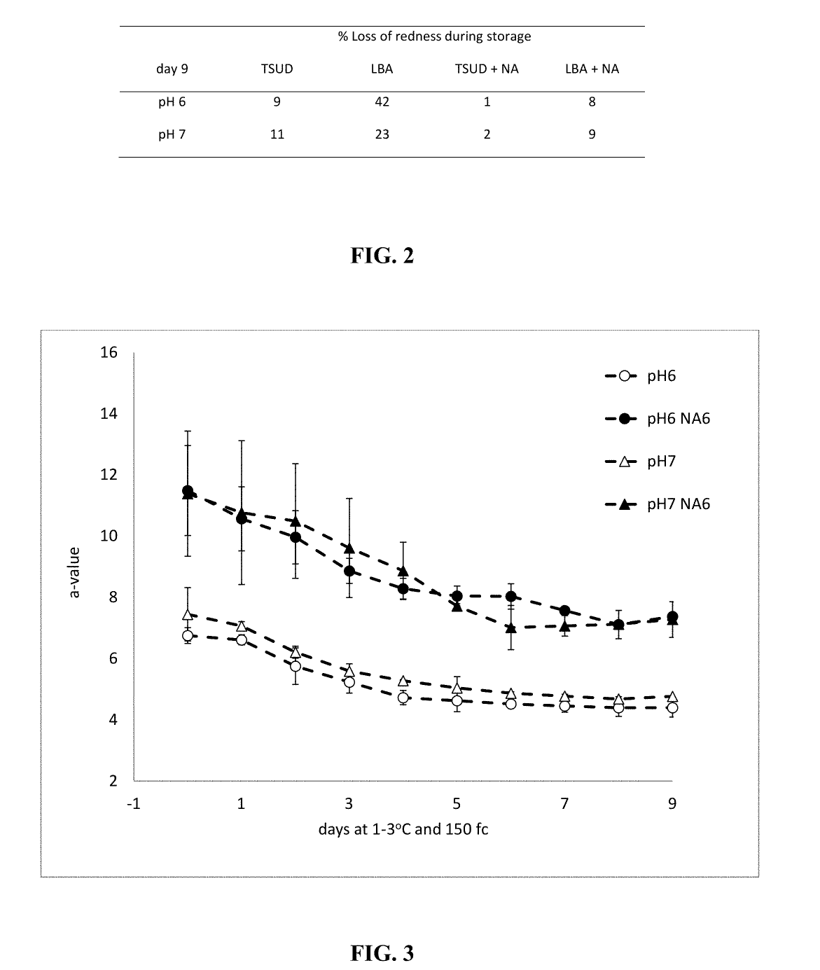

FIG. 2 shows the loss of redness (%) of clover leghemoglobin (TSUD) and soybean leghemoglobin (LBA) solutions during storage in the absence and presence of added nicotinic acid (NA) at pH 6 and 7. TSUD retained redness better than LBA during storage at pH 6 and pH 7. TSUD with added NA retained redness better than LBA with added NA during storage at pH 6 and pH 7.

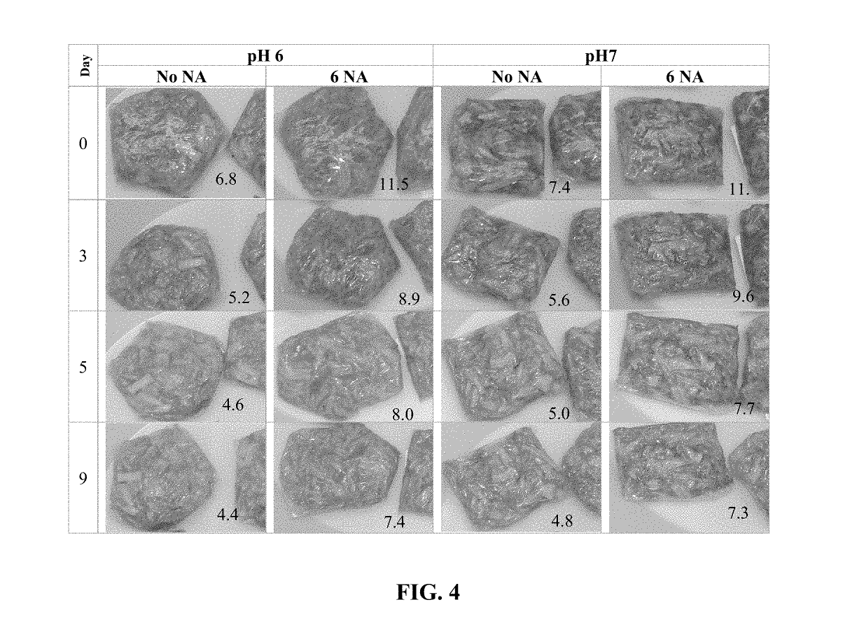

FIG. 3 shows the redness (a-values) of a wheat protein meat analog containing clover leghemoglobin (TSUD) at 160 μmol/kg (2.51 mg/g). Meat analog containing TSUD and NA had elevated redness during storage compared to meat analog containing TSUD at all times of storage at both pH 6 and pH 7.

FIG. 4 shown the redness (a-values) and images of meat analog containing 160 μmol of clover leghemoglobin (TSUD) per kg wet weight (2.51 mg/g) at pH 6 and pH 7, with or without 6 mol of nicotinic acid (6 NA) per mol of leghemoglobin. Meat analog containing TSUD and NA maintained desirable red color for 9 days of light display at pH 6 and pH 7 (all a-values greater than 7.2). Meat analog containing TSUD was more red at pH 7 compared to pH 6 at each time point of storage.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the disclosure as defined by the appended claims.

What is claimed is:

1. A method of improving storage life of a meat analog comprising introducing into said meat analog a clover hemoglobin.

2. The method of claim 1, wherein said clover hemoglobin is introduced at about 1-8 mg/g of meat analog, or 1-5 mg/g of meat analog.

3. The method of claim 1, wherein said clover hemoglobin is Trifolium subterraneum.

4. The method of claim 1, further comprising freezing said meat analog.

5. The method of claim 1, wherein said meat analog is treated at 0 to 6° C.

6. The method of claim 1, further comprising treating said meat analog with a preservative.

7. The method of claim 1, further comprising treating said meat analog with an additive.

8. The method of claim 1, wherein said meat analog retains red color and/or remains palatable at 0.6° C. for 2, 3, 4, 5, 6, 7, 8, 9, 10 or 14 days beyond the date upon which a meat analog not containing clover hemoglobin would no longer retain red color and/or be palatable.

9. The method of claim 1, further comprising adjusting the pH of the meat analog to about 6.0-7.2, to about 6.0-6.8, to about 6.0-6.3, or to about 6.0. 6.1, 6.2, 6.3, 6.4, 6.5, 6.6, 6.7, 6.8, 6.9, 7.0, 7.1 or 7.2.

10. The method of claim 9, wherein adjusting pH comprises adding an acid solution to the meat analog.

11. The method of claim 10, wherein the acid solution is hydrochloric acid solution, a sodium hydroxide acid solution, a citric acid solution, or sodium phosphate solution.

12. The method of claim 10, further comprising adding a buffering agent to stabilize pH of the meat analog.

13. A meat analog containing comprising about 1 to 8 mg/g clover hemoglobin.

14. The meat analog of claim 13, comprising about 1 to 5 mg/g clover hemoglobin.

15. The meat analog of claim 13, wherein said clover hemoglobin is Trifolium subterraneum.

16. The meat analog of claim 13, wherein said meat analog contains less than 5% non-clover plant hemoglobin.

17. The meat analog of claim 13, wherein the pH of the meat analog is about 6.0-7.2, to about 6.0-6.8, to about 6.0-6.3, or to about 6.0. 6.1, 6.2, 6.3, 6.4, 6.5, 6.6, 6.7, 6.8, 6.9, 7.0, 7.1 or 7.2.

18. The meat analog of claim 13, further comprising a buffering agent to stabilize pH of the meat analog.

19. A method of preparing a storage stable meat analog comprising:
(a) providing a meat analog;
(b) adding to said meat analog a clover hemoglobin; and
(c) packaging said meat analog for sale.

20. The method of claim 19, wherein the meat analog of step (c) has less than 55% non-clover plant hemoglobin.

21. The method of claim 19, further comprising contacting said meat analog with at least one additional additive or preservation agent prior to step (c).

22. The method of claim 19, further comprising freezing said meat analog after step (c).

23. The method of claim 18, wherein step (b) comprises treatment at −20 to 6° C.

24. The method of claim 18, wherein said clover hemoglobin is added at about 1-8 mg/g of meat analog, or 1-5 mg/g of meat analog.
